(19) United States
(12) Patent Application Publication
(10) Pub. No.: US 2008/0087386 A1
(43) Pub. Date: Apr. 17, 2008

(54) Combination structure of spring power assembly and head rail

(75) Inventors: Ming Nien, Lugang Township (TW); Yu-Che Wen, Gueishan Township (TW); Chih-Yao Chang, Taichung City (TW)

Correspondence Address: RABIN & Berdo, PC, 1101 14TH STREET, NW, SUITE 500, WASHINGTON, DC, 20005, US

(73) Assignee: Nien Made Enterprise Co., Ltd., Taichuang City (TW)

(21) Appl. No.: 11/580,900

(22) Filed: Oct. 16, 2006

(51) Int. Cl. E06B 9/30

(52) U.S. Cl. 160/170

(57) ABSTRACT

A combination structure of a spring power assembly and a head rail is provided. A revolving shaft of a power spring is made to be perpendicular to a major axis of the head rail, so as to reduce the height of the head rail. The head rail has a first gripping part and the spring power assembly has a second gripping part corresponding to the first gripping part and a bayonet pin, which prevents the spring power assembly from being placed into the head rail along a wrong direction and/or prevents the spring power assembly from rotating along a wrong direction, so as to avoid damages to the spring power assembly caused by errors in the assembling process.

### BACKGROUND OF THE INVENTION

1. Field of Invention

The present invention relates to a spring power assembly structure and a combination structure of a spring power assembly and a head rail, and more particularly, to a directionality when the spring power assembly is assembled with the head rail, and a modular structure of the spring power assembly.

2. Related Art

Generally speaking, a cordless shutter structure is driven by a spring housing or an electric motor, and the spring housing is a common means for driving. Related arts, such as U.S. Pat. Publications No. 5,482,100, 5,531,257, and 6,234,236, have disclosed that a spring motor is used as a power source for rotation, and a cord spool is fixed at one side of the spring motor, such that the spring motor directly drives the cord spool to rotate and thereby winding cords.

Additionally, U.S. Pat. Publication No. 6,056,036 has also disclosed that, a spring assembly composed of a power spring is used as a power source for rotation, the spring assembly is disposed in a head rail, and a shaft is disposed in the head rail and passes through the spring assembly, such that the shaft is driven by the spring assembly to rotate. Then, the shaft further passes through a spool assembly and drives it to rotate and thereby winding cords. A plurality of spring assemblies may be serially connected on the shaft to enhance the rotating force for the shaft. However, for the spring assembly disclosed in U.S. Pat. Publication No. 6,056,036, the revolving shaft is parallel to the axis of the shaft and the longitudinal direction of the head rail. However, the overall longwise direction of the power spring is perpendicular to the direction of the revolving shaft. Therefore, due to such assembling method, the longwise direction of the spring assembly is perpendicular to the longitudinal direction of the head rail, which causes the width and height of the head rail to be increased.

Additionally, as disclosed in U.S. Pat. Publication No. 6,283,192, a spring driver unit is accommodated within a housing, a transmission shaft is pivotally disposed in the housing, and a bevel gear set is used to transmit power between the spring driver unit and the transmission shaft. However, in U.S. Pat. Publication No. 6,283,192, no modular design is provided between the spring driver unit and the transmission shaft. Therefore, a lot of time and cost must be spent on assembling and maintenance.

However, the spring housing uses the power spring as a power source, therefore, as for the spring housing, the rotation direction of the load and the rotation direction of the recovery of the spring are specified in advance and cannot be alternately used. If they are alternately used, the power spring will be damaged. Furthermore, when being assembled by a common user, it may often be assembled incorrectly, and thereby damaging the spring housing.

### SUMMARY OF THE INVENTION

In view of the above problems, the present invention is directed to providing a combination structure of a spring power assembly and a head rail, so as to make the spring power assembly to be modularly designed and achieve the directionality in assembling the spring power assembly with the head rail. Additionally, the spring power assembly has stopping characteristic, so as to enhance the convenience in assembling and maintenance.

Therefore, the present invention discloses a combination structure of a spring power assembly and a head rail, wherein the spring power assembly is integrated and assembled into the head rail, a revolving shaft of a power spring assembled into the spring power assembly is perpendicular to the direction of a shaft passing through the spring power assembly, thereby reducing the required volume of the spring power assembly. The head rail comprises a front wall, a rear wall, and a connection portion. The front wall and the rear wall are connected via the connection portion to form a fore and aft arrangement, and an accommodation space is formed between the front wall and the rear wall. A first gripping part is formed in the front wall and a second gripping part is formed at the outer edge of the housing of the spring power assembly. When the first gripping part faces the front, the second gripping part stops at one end of the accommodation space to prevent the spring power assembly from entering into the accommodation space.

Furthermore, in order to assemble the spring power assembly more conveniently, a bayonet pin is used to stop the spring power assembly; thus, the spring power assembly may be kept in an initial state when being assembled. In addition, if the spring power assembly rotates wrongly due to an external force, it may be stopped instantly by using the bayonet pin, so as to reduce the damage to the spring power assembly.

In view of the above, the combination structure of the spring power assembly and the head rail provided by the present invention makes the spring power assembly be a modular design, and the spring power assembly and the head rail are designed to be unique in assembling, so as to ensure the spring power assembly to be assembled correctly, and thereby preventing the spring power assembly from being damaged due to the wrong assembling direction. Besides that the uniqueness of the assembling method is utilized to prevent the spring power assembly from being damaged, the spring power assembly has a stopping mechanism to stop the spring power assembly timely, and thereby achieving the efficacy of reducing the damage to the spring power assembly.

The features and practice of the present invention are illustrated below in detail through preferred embodiments with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic assembled view for a spring power assembly of the present invention to be applied in a shutter;

FIG. 2 is a schematic assembled view of the spring power assembly of the present invention;

FIG. 3 is a schematic exploded view of the spring power assembly of the present invention;

FIGS. 4A and 4B are different schematic views for the spring power assembly of the present invention to be assembled into the head rail;

FIGS. 5A, 5B, and 5C are schematic views of locking actions of a bayonet pin of the present invention;

FIGS. 6A and 6B are schematic views for the bayonet pin of the present invention to be locked in the top cover; and

FIG. 7 is a schematic view of a shaft of the present invention serially connected with two spring power assemblies.

### DETAILED DESCRIPTION OF THE INVENTION

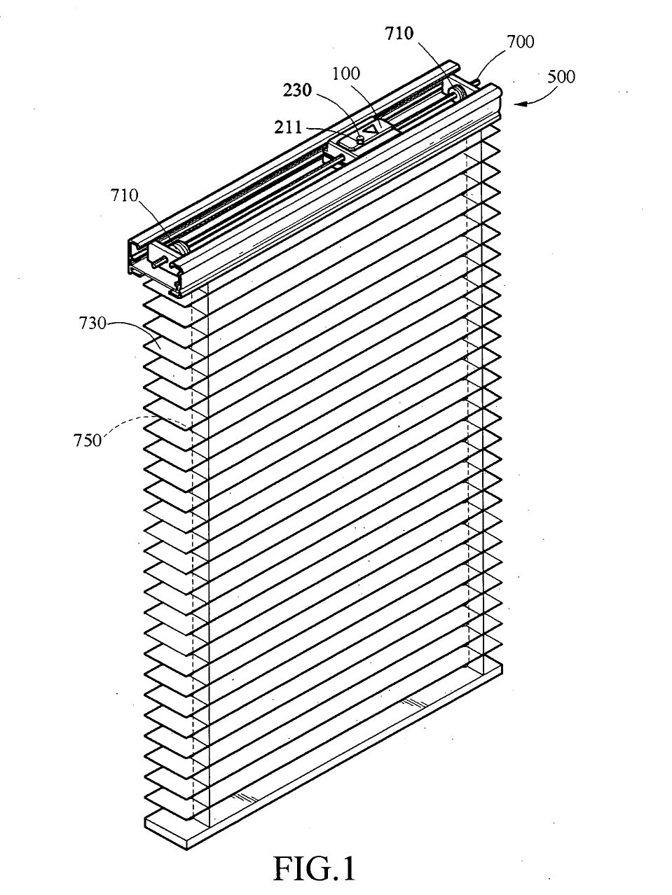

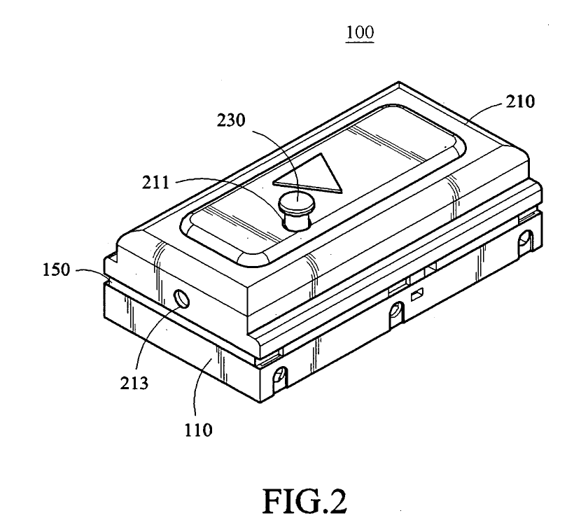

As shown in FIGS. 1, 2, and 3, they are respectively a schematic assembled view for a spring power assembly of the present invention to be applied in a shutter, a schematic assembled view of the spring power assembly of the present invention, and a schematic exploded view of the spring power assembly of the present invention. A spring power assembly 100 and a cord pulley 710 are assembled in a head rail 500, and a shaft 700 passes through the spring power assembly 100 and the cord pulley 710. The spring power assembly 100 may generate a torsional force to rotate the shaft 700, so as to further drive the cord pulley 710 to rotate and thereby winding a lift cord 750 passing through a plurality of slats 730.

The spring power assembly 100 includes a housing composed of a base 110, a middle cover 150, and a top cover 210, wherein a power spring 130, a first transmission element, and a second transmission element are assembled into the housing.

The power spring 130 is disposed on one side of the base 110, and in this embodiment, it lies at the bottom of the base 110 with a suitable depth. The middle cover 150 covers the base 110 to ensure that the power spring 130 rotates in the base 110. The first transmission element and the second transmission element are a first bevel gear 170 and a second bevel gear 190, wherein the first bevel gear 170 is connected to the power spring 130, and the second bevel gear 190 is pivotally disposed on the middle cover 150 and engaged with the first bevel gear 170. When the power spring 130 drives the first bevel gear 170 to rotate along a first direction, the second bevel gear 190 rotates correspondingly along a second direction. In the design that a revolving shaft of the power spring 130 is perpendicular to the direction of the shaft 700, besides utilizing a bevel gear set as the transmission elements, the engagement of friction gears may be also utilized to achieve the same function.

The power spring 130 of the present invention lies in the base 110, so as to reduce the height of the whole spring power assembly 100, thus, a head rail 500 with a small height may be selected for the shutter that uses the spring power assembly 100.

The top cover 210 covers the middle cover 150 to prevent the foreign objects from sticking on the gear teeth of the first bevel gear 170 and the second bevel gear 190 to negatively affect the transmission fluency. In another aspect, installers are protected from being hurt during installation. As for the integrated design of the spring power assembly 100, a modular design is achieved.

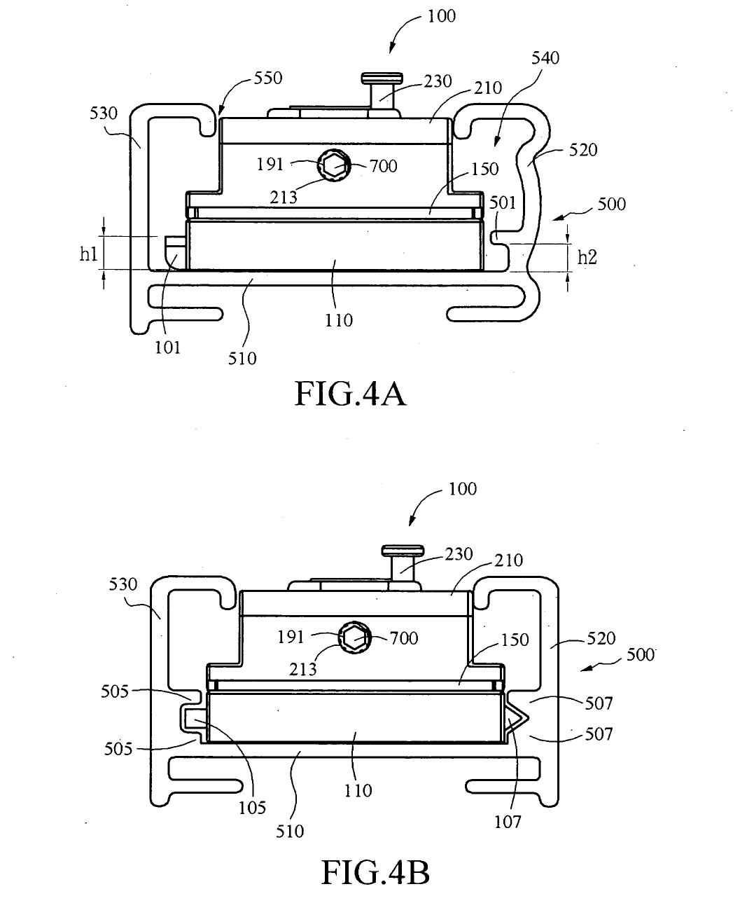

As shown in FIGS. 4A and 4B, they are different schematic views for the spring power assembly of the present invention to be assembled into the head rail. A torsional force generated due to the elastic force of the spring power assembly 100 is applied to the spring power assembly 100 via a load side in a specific rotation direction; thus, the power spring 130 will be damaged if being forced to rotate in an inverse direction. Therefore, the spring power assembly 100 should be assembled in the head rail 500 in a specific direction.

As shown in FIG. 4A, the head rail 500 has a strip-shaped connection portion 510, and a front wall 520 and a rear wall 530 are disposed on two sides of the connection portion 510 respectively, and extend for a suitable distance parallel to the major axis. An accommodation space 540 is defined among the connection portion 510, the front wall 520, and the rear wall 530. A first gripping part 501 is disposed in an inner side of the front wall 520 and shaped like a bearing rib.

In the spring power assembly 100, the second gripping part 101 is a bump formed on one side of the housing facing the rear wall 530. The distance h1 between the second gripping part 101 and the spring power assembly 100 is larger than the distance h2 between the first gripping part 501 of the head rail 500 and the connection portion 510. Therefore, when the second gripping part 101 faces the front, and the spring power assembly 100 is to be placed into the head rail 500, the first gripping part 501 and the second gripping part 101 are mutually contradicted, such that the spring power assembly 100 cannot enter into the head rail 500, thereby achieving the fool-proofing effect. On the contrary, the spring power assembly 100 is allowed to be disposed in the head rail 500 (as shown in FIG. 4A). Additionally, an opening 550 of the head rail 500 is formed between the front wall 520 and the rear wall 530, opposite to the connection portion 510. The width of the opening 550 is consistent with that of the top cover 210 of the spring power assembly 100 and less than that of the base 110, such that the spring power assembly 100 can only be embedded into the head rail 500 laterally from one end of the head rail 500 along the major axis direction, and it cannot be directly assembled into the head rail 500 by passing through the opening 550 of the head rail from top to bottom.

As shown in FIG. 4B, if the spring power assembly 100 has a plurality of second gripping parts, the head rail 500 must be disposed with a plurality of first gripping parts correspondingly, wherein the gripping parts may have different shapes. For example, a pair of wedge-shaped first gripping parts 507 are disposed on the inner side of the front wall 520, so as to form a triangular space there-between, while a pair of rectangle-shaped first gripping parts 505 are disposed in the inner side of the rear wall 530, so as to form a rectangular space there-between, which are respectively corresponding to the triangular second gripping parts 107 and rectangular second gripping parts 105 disposed on both sides of the spring power assembly 100 respectively. Through the stopping effects between the rectangle-shaped and wedge-shaped first gripping parts 505 and 507 and rectangular and triangular second gripping parts 105 and 107, the spring power assembly 100 is protected from being damaged when being assembled to the head rail 500 along a wrong direction.

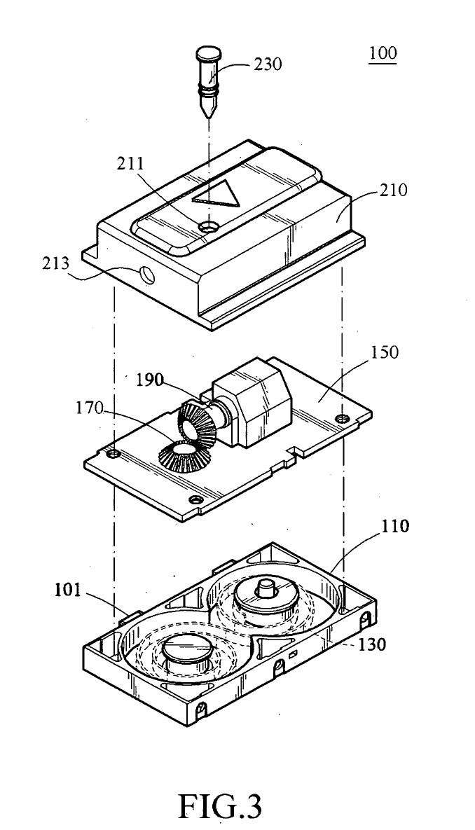

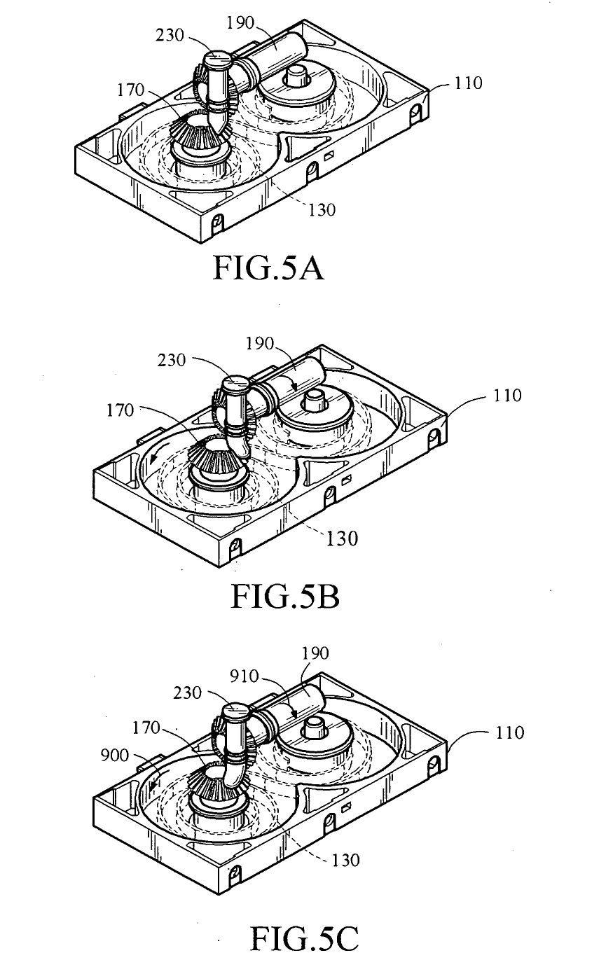

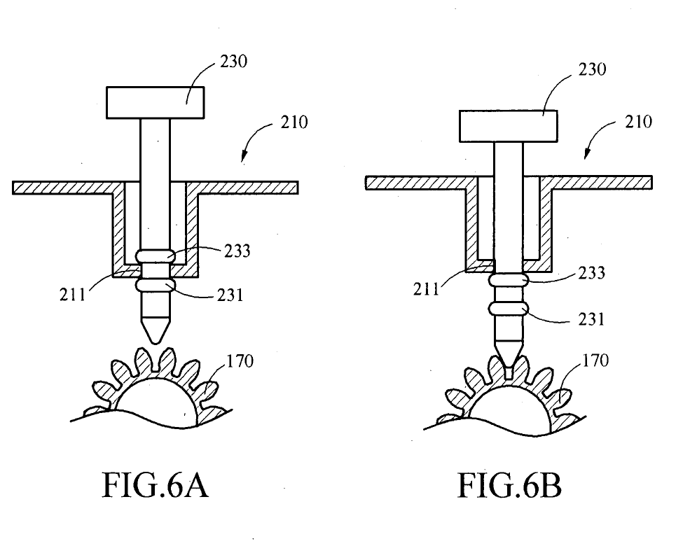

Besides a fool-proof mechanism disposed in the combination structure of the spring power assembly 100 and the head rail 500, another fool-proof mechanism is also disposed in the spring power assembly 100. Referring to FIGS. 5A, 5B, and 5C, they are schematic views of locking actions of a bayonet pin of the present invention. As shown in FIGS. 3 and 5A, the spring power assembly 100 further includes a bayonet pin 230, and a clipping hole 211 is opened in the top cover 210 facing the engagement position of the first bevel gear 170 and the second bevel gear 190. The bayonet pin 230 passes through the clipping hole 211. Then, the bayonet pin 230 may be adjusted along the major axis direction to move between a first position (as shown in FIG. 6A) and a second position (as shown in FIG. 6B) relative to the top cover 210, and thereby, the bayonet pin 230 is adjusted to whether touch the first bevel gear 170 or not. One end of the bayonet pin 230 that touches the first bevel gear 170 is a free end, which is swung when under force. The bayonet pin 230 is made of an elastic material, such as rubber.

As shown in FIG. 5B, under the circumstance that the bayonet pin 230 is at the second position and touches the first bevel gear 170, when the first bevel gear 170 does not rotate along a first direction 900 (as shown in FIG. SC) due to incorrect installation, the free end of the bayonet pin 230 is driven to be wedged in the engagement position of the first bevel gear 170 and the second bevel gear 190, thereby preventing the rotation of the first bevel gear 170.

As shown in FIG. 5C, under the circumstance that the bayonet pin 230 is at the second position and touches the first bevel gear 170, when the first bevel gear 170 rotates along the first direction 900 correctly, the bayonet pin 230 is driven by the first bevel gear 170 and deformed, but, the swinging direction of the bayonet pin 230 is far away from the engagement position of the first bevel gear 170 and the second bevel gear 190, and thus the bayonet pin 230 will not bear against the engagement position. As such, the first bevel gear 170 continuously rotates along the first direction 900 and drives the second bevel gear 190 to rotate along a second direction 910. When the spring power assembly 100 has been correctly assembled, the bayonet pin 230 can be taken off, so as to prevent the bayonet pin 230 from still touching the first bevel gear 170, and thereby reducing the rotation resistance of the first bevel gear 170.

As shown in FIGS. 6A and 6B, they are schematic views for the bayonet pin to be locked in the top cover. A first clipping ring 231 and a second clipping ring 233 are formed on the peripheral surface of the bayonet pin 230. As shown in FIG. 6A, when the bayonet pin 230 is at the first position, the first clipping ring 231 and the second clipping ring 233 are respectively locked above and below the clipping hole 211 of the top cover 210, and the free end of the bayonet pin 230 does not bear against the first bevel gear 170, such that the first bevel gear 170 and the second bevel gear 190 may rotate freely, and the bayonet pin 230 is prevented from drooping off the clipping hole 211. As shown in FIG. 6B, when the bayonet pin 230 is driven towards the first bevel gear 170 to be placed at the second position, the second clipping ring 233 is below the clipping hole 211, the free end of the bayonet pin 230 is embedded in the gear teeth of the first bevel gear 170.

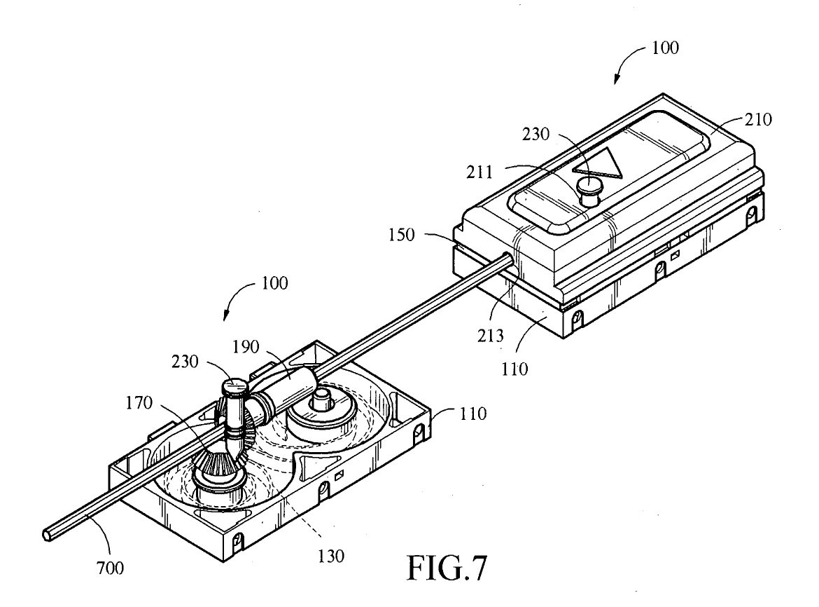

Referring to FIG. 7, it is a schematic view of a shaft of the present invention serially connected with two spring power assemblies. As shown in FIGS. 4A and 7, the second bevel gear 190 has a shaft hole 191 with an inner edge of the cross section as a polygon. An opening 213 is opened in the two ends of the top cover 210 corresponding to the shaft 700, such that the shaft 700 with a polygonal cross section passes through the opening 213 and then passes through the shaft hole 191 of the second bevel gear 190, so as to make the second bevel gear 190 drive the shaft 700 to rotate. With such a design, a plurality of spring power assemblies 100 is connected in series to the shaft 700, and they may have the same or different torsional forces, thereby providing the torsional force required by the shaft.

Therefore, by utilizing a modular design of the spring power assemblies, the combination structure of the spring power assembly and the head rail has a fool-proof mechanism. The assembling process can be finished simply and quickly, and the maintenance or replacement also can be achieved simply and quickly. In addition, the function of the bayonet pin is to stop the first bevel gear to maintain the preset status of the power spring, which is convenient for the assembling process and providing the fool-proof function.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A combination structure of a spring power assembly and a head rail, comprising:
a head rail, comprising:
a connection portion;
a front wall and a rear wall, respectively disposed in front of and behind the connection portion, being parallel to each other, and extending for a predetermined length, wherein an accommodation space is defined between the connection portion and the front and rear walls, and the accommodation space has an opening opposite to the connection portion; and
a first gripping part, protrudingly disposed on an inner side of the front wall; and
a spring power assembly, comprising:
a housing, wherein some part has a width being larger than that of the opening, such that the housing is placed into the accommodation space from one end of the head rail parallel to a major axis of the head rail;
a power spring, placed in the housing;
a first transmission element, pivotally disposed in the housing and driven by the power spring to rotate along a first direction;
a second transmission element, pivotally disposed in the housing and driven by the first transmission element to rotate along a second direction; and
a second gripping part, protrudingly disposed on an outer edge of the housing, corresponding to the first gripping part;
wherein when the first gripping part faces front, the second gripping part stops at one end of the accommodation space to prevent the spring power assembly from entering into the accommodation space.

2. The combination structure of a spring power assembly and a head rail as claimed in claim 1, wherein the housing comprises:
a base; and
a middle cover, disposed on the base, wherein the power spring is disposed between the middle cover and the base;
wherein the first transmission element is pivotally disposed in the middle cover and connected to the power spring with a predetermined part; and the second transmission element is pivotally disposed in the housing and driven by the first transmission by way of engagement.

3. The combination structure of a spring power assembly and a head rail as claimed in claim 1, wherein through one bevel gear disposed on the first transmission elements the first transmission element drives the second transmission element that is also disposed with another bevel gear.

4. The combination structure of a spring power assembly and a head rail as claimed in claim 1, wherein the spring power assembly further comprises a bayonet pin, a predetermined part of the bayonet pin moves between a first position and a second position, and when at the second position, the predetermined part is wedged between the first transmission element and the second transmission element, such that the first transmission element is restricted to only drive the second transmission element to rotate along the first direction and the second direction respectively.

5. The combination structure of a spring power assembly and a head rail as claimed in claim 3, wherein the spring power assembly further comprises a bayonet pin, a predetermined part of the bayonet pin moves between a first position and a second position, and when at the second position, the predetermined part is wedged between the first transmission element and the second transmission element, such that the first transmission element is restricted to only drive the second transmission element to rotate along the first direction and the second direction respectively.

6. The combination structure of a spring power assembly and a head rail as claimed in claim 4, wherein the part of the bayonet pin wedged between the first transmission element and the second transmission element is elastic.

7. The combination structure of a spring power assembly and a head rail as claimed in claim 5, wherein the part of the bayonet pin wedged between the first transmission element and the second transmission element is elastic.

8. The combination structure of a spring power assembly and a head rail as claimed in claim 1, further comprising the first gripping part that is protrudingly disposed on an inner side of the rear wall.

9. A combination structure of a spring power assembly and a head rail, comprising:
a head rail, comprising:
a connection portion; and
a front wall and a rear wall, respectively disposed in front of or behind the connection portion, being parallel to each other, and extending for a predetermined length, wherein an accommodation space is defined between the connection portion and the front and rear walls, and the accommodation space has an opening opposite to the connection portion; and
a spring power assembly, comprising:
a housing, disposed in the accommodation space;
a power spring, disposed in the housing;
a first transmission element, pivotally disposed in the housing and driven by the power spring to rotate along a first direction;
a second transmission element, pivotally disposed in the housing and driven by the first transmission element to rotate along a second direction; and
a bayonet pin, disposed on the housing, wherein a predetermined part of the bayonet pin moves between a first position and a second position, and when at the second position, the predetermined part is wedged between the first transmission element and the second transmission element, so as to prevent the first transmission element from driving the second transmission element to rotate.

10. The combination structure of a spring power assembly and a head rail as claimed in claim 9, wherein the housing comprises:
a base; and
a middle cover, disposed on the base, wherein the power spring is disposed between the middle cover and the base;
wherein the first transmission element is pivotally disposed on both the base and the middle cover with the predetermined part; and the second transmission element is pivotally disposed in the middle cover and driven by the first transmission element by way of engagement.

11. The combination structure of a spring power assembly and a head rail as claimed in claim 9, wherein through one bevel gear disposed on the first transmission element, the first transmission element drives the second transmission element that is also disposed with another bevel gear.

12. The combination structure of a spring power assembly and a head rail as claimed in claim 9, wherein the part of the bayonet pin wedged between the first transmission element and the second transmission element is elastic.

13. The combination structure of a spring power assembly and a head rail as claimed in claim 9, wherein the housing further comprises a top cover with a clipping hole facing the combination position of the first transmission element and the second transmission element; the bayonet pin passes through and is accommodated in the clipping hole; and the bayonet pin has at least one clipping ring on-the peripheral surface, which has an outside diameter greater than an inner diameter of the clipping hole.

14. The combination structure of a spring power assembly and a head rail as claimed in claim 10, wherein the housing further comprises a top cover with a clipping hole facing the combination position of the first transmission element and the second transmission element; the bayonet pin passes through and is accommodated in the clipping hole; and the bayonet pin has at least one clipping ring on the peripheral surface, which has an outside diameter greater than an inner diameter of the clipping hole.

15. The combination structure of a spring power assembly and a head rail as claimed in claim 1, further comprising a shaft, wherein the second transmission element has a shaft hole running through two ends of the transmission element and extending parallel to the major axis of the head rail, such that the shaft passes through the shaft hole to interlock with the second transmission element.

16. The combination structure of a spring power assembly and a head rail as claimed in claim 9, further comprising a shaft, wherein the second transmission element has a shaft hole running through two ends of the transmission element and extending parallel to the major axis of the head rail, such that the shaft passes through the shaft hole to interlock with the second transmission element.

17. The combination structure of a spring power assembly and a head rail as claimed in claim 15, wherein an inner edge of a cross section of the shaft hole is a polygon, and the shaft has a corresponding polygonal outer edge.

18. The combination structure of a spring power assembly and a head rail as claimed in claim 16, wherein an inner edge of a cross section of the shaft hole is a polygon, and the shaft has a corresponding polygonal outer edge.
